(19) United States
(12) Patent Application Publication
(10) Pub. No.: US 2002/0167657 A1
(43) Pub. Date: Nov. 14, 2002

(54) Method for estimating the lighting quality of vehicle headlights

(76) Inventor: Targosinski Tomasz, Warszawa (PL)

Correspondence Address: JASPAN SCHLESINGER HOFFMAN LLP, 300 Garden City Plaza, Gardens City, NY, 11530, US

(21) Appl. No.: 10/091,662

(22) Filed: Mar. 6, 2002

(30) Foreign Application Priority Data
Aug. 28, 2000 (PL) P-335553

(51) Int. Cl. G01J 1/00

(52) U.S. Cl. 356/121

(57) ABSTRACT

A method for the determination of the lighting quality of vehicle headlights, particularly automobile headlights, comprising the steps of directing the light of each headlight onto a screen, measuring the distribution of illumination on the screen or the luminous intensity distribution in a solid angle of the emitted light beam, transforming the obtained results by known geometric methods using a computer program to the real distribution of vertical illumination on the road surface, using these transformed results to calculate light quality values such as Mₖ for the illumination of the road, Nₗ for the glare experienced by the drivers, k for sector Sₖ established for the road surface and its surroundings, and l for the sector Sₗ established for the surface at the eye-level of the glare exposed drivers, and thereafter comparing the calculated light quality values to the required values for headlamps to determine the lighting quality of the vehicle headlights.

A matter of the invention is a method for estimating the lighting quality of vehicle headlights particularly automobile headlights.

The invention has an application in the vehicle control stations as well as in the laboratories for testing of vehicle headlights, especially automotive headlights during the process of its designing, constructing and exploitation.

In Regulation No 20 of the United Nations Organisation—Economic Commission for Europe—E/ECE/324-EIECE/TRANS/505/Rev. 1/Add. 19/Rev.2.—is described a method of estimation the lighting quality of car headlights. The method relies upon that the light beam emitted from the tested vehicle headlamp is projected on the screen situated perpendicularly to the optical axis of the headlamp and in the fixed distance from it. Then in the definite points and areas of that screen the illumination is measured by luxmeter and the results of these measurements are indicated in a table and compared with the required values. There is a modification of this method in which the values of the tested headlamp illumination are obtained by measuring the luminous intensity of the headlamp by goniophotometer in a solid angle of the emitted light beam.

The main disadvantage of the described methods is that the estimation of the lighting quality of the vehicle headlights is being taken only for one headlamp and that the values of illumination are obtained from the surface of a screen situated perpendicularly to the emitted light beam. However, the surface of the screen does not reflect the road surface observed by a driver. The driver observes the road and its closest surrounding on a surface which is parallel to the optical axis of car headlamps. Furthermore, in the described methods the lighting quality is estimated for the constant distance between the tested headlamp and measuring device, and for these conditions the requirements are defined, whereas, the illuminated points of the lighting road are in different distances depending on the setting of headlamps on the vehicle. Therefore, the described methods do not correspond to the real conditions of illuminated objects observed on a road and they do not reflect the real lighting characteristics, for one vehicle headlamp and especially for the set of head-lamps installed on a vehicle. In fact, the distribution of illumination of vehicle headlamps is entirely different on the road surface from the one on the screen. Therefore, the measured results do not correspond to the real illumination conditions existed on the road and consequently the estimation of the lighting quality of tested headlamp is incorrect.

A method according to the invention is free of the disadvantages described above.

The matter of the invention relies on that the obtained distribution of illumination on a screen or the luminous intensity in a solid angle for each tested headlamp is first transformed, by the known geometric methods, to the real distribution of vertical illumination on the road surface, where the vertical illumination means the illumination on the plane perpendicular to the vehicle axis and then all the such obtained distributions of vertical illumination for each headlamp of the tested set are summarised giving a final distribution of vertical illumination E_{d}. In the same way, the real distribution of vertical illumination on the surface parallel to the road, lying on the eye-level of the glared drivers, is calculated and then all the such obtained illumination distributions for each headlamp of the tested set are summarised giving a final distribution of vertical illumination Eₒ. On the basis of these results some measure values of lighting quality are calculated, which are the numerical values Mₖ in the case of illumination of the road and the numerical values Nₗ in the case of the eyes of glared drivers. Calculations are made for some numbers k of sectors Sₖ established for the road surface and their surrounding, and for some numbers l of sectors Sₗ established for the surface at the eye-level of the glared drivers. The obtained results are compared with the required values.

The numerical values Mₖ are calculated according to the following mathematical formula

$${M}_{k} = \frac{{\int }_{{S}_{k}} {E}_{r d} \cdot ⅆ {S}_{k}}{a \cdot {E}_{a} {S}_{k}}$$

where E_{rd} is the value of illumination used for the calculation, on the conditions that E_{rd}=E_{d} when E_{d}≧Eₚᵣ or alternatively E_{rd}=0 when E_{d}<Eₚᵣ, where Eₚᵣ is the threshold illumination in which the human eye can see anything, Eₐ is the illumination on the surface of the drivers eye, caused by the light of tested headlamps and responsible for the sight adaptation level of the driver's eye, a is a constant number which reflects proportion between the illumination on the surface of the eye and the illumination close to the road surface, dSₖ is a differential of the area of tested sector k and, Sₖ is the whole area of the sector k.

The numerical values Nₗ are calculated according to the following mathematical formula

$${N}_{I} = \frac{{\int }_{{S}_{I}} ( {E}_{oe} \cdot cos α - {E}_{op} ) \cdot ⅆ {S}_{I}}{{E}_{op} {S}_{I}}$$

where Eₒₑ is the value of illumination used for the calculation, on the conditions that Eₒₑ=Eₒ when Eₒ·cos α≧Eₒₚ or alternatively Eₒₑ=Eₒₚ when Eₒ·cos α<Eₒₚ, where α is an angle between the sight line of the driver and the light beam causing the glare, Eₒₚ is the threshold glare illumination on the surface of the eye, dSₗ is a differential of the area of tested sector l and, Sₗ is the whole area of the sector l.

The value of parameter Eₐ existing in the first formula is favourable to calculate from the following mathematical formula

$${E}_{a} = {\int }_{ω} {L}_{d} \cdot cos θ \cdot ⅆ ω$$

or alternatively from the another mathematical formula

$${E}_{a} = b \cdot \frac{{\int }_{{S}_{e}} {E}_{da} \cdot ⅆ {S}_{e}}{{S}_{e}}$$

where L_{d} is the luminance of the road observed by a driver and caused by the tested headlamps, ω is a solid angle with its top in the driver's eye where the illuminating surface of the road exists or a part of this angle in which there is the greatest luminance of the road responsible for the sight adaptation level of the human eye, b is a constant number which reflects the proportion between the illumination on the surface of the road and the illumination on the surface of the eye, θ is an angle between the line perpendicular to the surface of the drivers eye and the incident light beam, E_{da} is the illumination on the surface of the road which causes the luminance responsible for sight adaptation level of the drivers eyes, Sₑ is the area of a plane which is perpendicular to the direction of the driver's sight line and through which the light beams reflecting from the road incident to the eyes, dSₑ is a differential of the area Sₑ.

It is favourable when all the values of illumination and luminance used for the calculations are replaced by proportional non-linear functions, best by the logarithmic function. It is also favourable when all the above mathematical calculations are carried out by means of computerised numerical methods.

The main advantage of a method according to the invention is that it allows to evaluate the real illumination of the road surface, both for the one tested headlamp as for the set of two or more headlamps installed on the vehicle. This method enables to estimate the actual illumination quality of the vehicle headlamps on the road and their surrounding. The method uses a very important factor as a sight adaptation level of the drivers eyes to the illuminated road surface and objects. By this method one can estimate the real light quality for the set of tested vehicle headlamps.

An example of the invention is showed as follow:

A set of two headlamps is tested. For each headlamp from this set, by means of a goniophotometer, the illumination distribution on the screen surface situated in the distance of 25 meters is measured. The results in digital form are stored on a computer disc. Then, by means of a computer program, the results are transformed according to the known geometrical methods to the distribution of vertical illumination on the road surface, whereas the vertical illumination is defined for the plane perpendicular to the vehicle axis. The obtained values for each of the two headlamps are summarised giving the final distribution of vertical illumination E_{d}. Then, on the road surface some number of k sectors are established, in this example eight; S₁, S₂, . . . , S₈, for whose the numerical values Mₖ are calculated according to the following mathematical formula

$${M}_{k} = \frac{{\int }_{{S}_{k}} {E}_{r d} \cdot ⅆ {S}_{k}}{a \cdot {E}_{a} {S}_{k}}$$

where the constant factor a was established as 1, the value E_{rd} was used according to the following conditions: E_{rd}=E_{d} when E_{d}≧Eₚᵣ or alternatively E_{rd}=0 when E_{d}<Eₚᵣ where Eₚᵣ, as the treshold illumination, was used as Eₚᵣ=(0,05×Eₐ), while the value Eₐ was calculated from the following mathematical formula

$${E}_{a} = b \cdot \frac{{\int }_{{S}_{e}} {E}_{da} \cdot ⅆ {S}_{e}}{{S}_{e}}$$

where the constant factor b was used as 1000, the value E_{da} was used as equal to the value E_{d} and the value Sₑ, as a plane surface perpendicular to the direction of the driver's sight line, was calculated from the relation between the illuminated road surface and the angle of observation of the driver.

In the similar way from the mathematical formula

$${N}_{I} = \frac{{\int }_{{S}_{I}} ( {E}_{oe} \cdot cos α - {E}_{op} ) \cdot ⅆ {S}_{I}}{{E}_{op} {S}_{I}}$$

are calculated the values of estimation of a glare illumination for the two established sectors S₉ and S₁₀ of the driver's eyes, the first one on the left side for the oncoming driver and the second one on the right side for the preceding driver.

All the above calculations were made by means of the computer program. The final result of these calculations, were the numerical values of light estimation M₁, M₂, . . . M₈, suiting for sectors S₁, S₂, . . . S₈ of the illuminating road surface and the numerical values of light estimation N₁, N₂, correspondingly to sectors S₉, S₁₀ of the glare surface. The obtained results are presented in the following table:

| Sectors | Results | Requirements |
|---|---|---|
| Sectors of road | | |
| surface | Mₖ | Mₖ |
| S₁ | 0.862 | >0.750 |
| S₂ | 0.571 | >0.500 |
| S₃ | 0.192 | >0.150 |
| S₄ | 0.027 | >0.020 |
| S₅ | 0.929 | >0.750 |
| S₆ | 0.659 | >0.500 |
| S₇ | 0.220 | >0.200 |
| S₈ | 0.046 | >0.030 |
| Sectors of glare | | |
| surface | N₁ | N₁ |
| S₉ | 0.169 | <0.500 |
| S₁₀ | 0.278 | <0.800 |

Comparing the obtained results with the required values, it is possible to estimate the light quality of the two tested headlamps. In this example the tested set of headlamps meets the established requirements.

1. A method for estimating the lighting quality of vehicle headlights particularly automobile headlights, where for each tested headlamp the distribution of illumination on a screen or the luminous intensity distribution in a solid angle of emitted light beam is measured and the obtained results are compared with the required values characterised that the obtained illumination or luminance distribution for each tested headlamp is first transformed, by the known geometric methods, to the real distribution of vertical illumination on the road surface and then all the such obtained light distributions for all headlamps of the tested set are summarised giving a final distribution of vertical illumination E_{d}, and that in the same way the real distribution of vertical illumination on the surface parallel to the road, lying on the eye-level of the glared drivers, is calculated and then all the such obtained illumination distributions for each headlamp of the tested set are summarised giving a final distribution of vertical illumination Eₒ, and that from the such obtained results some measure values of lighting quality are calculated, which are the numerical values Mₖ for illumination of the road and the numerical values Nₗ for the eyes of glared drivers, wherein the said calculations are made for some numbers k of sectors Sₖ established for the road surface and their surrounding, and for some numbers l of sectors Sₗ established for the surface at the eye-level of the glared drivers.

2. A method according to claim 1 characterised that the numerical values Mₖ are calculated from the following mathematical formula
$${M}_{k} = \frac{{\int }_{{S}_{k}} {E}_{r d} \cdot ⅆ {S}_{k}}{a \cdot {E}_{a} {S}_{k}}$$
where E_{rd} is the illumination value used for the calculation, on the conditions that E_{rd}=E_{d} when E_{d}≧Eₚᵣ, or alternatively E_{rd}=0 when E_{d}<Eₚᵣ where Eₚᵣ is the threshold illumination in which the human eye can see anything, Ea is the illumination on the surface of the driver's eye caused by the light of the tested headlamps and responsible for the sight adaptation level of driver's eye, a is a constant number, reflecting the proportion between the illumination on the surface of the eye and illumination close to the road surface, dSₖ is a differential of the area of tested sector k and, Sₖ is the whole area of the sector k, while the numerical values N, are calculated according to the following mathematical formula
$${N}_{I} = \frac{{\int }_{{S}_{I}} ( {E}_{oe} \cdot cos α - {E}_{op} ) \cdot ⅆ {S}_{I}}{{E}_{op} {S}_{I}}$$
where Eₒₑ is the value of illumination used for the calculation, on the conditions that Eₒₑ=Eₒ when Eₒ·cos α≧Eₒₚ or alternatively Eₒₑ=Eₒₚ when Eₒ·cos α<Eₒₚ where α is an angle between the sight line of the driver and the light beam causing the glare, Eₒₚ is the threshold glare illumination on the surface of the eye, dSₗ is a differential of the area of tested sector l and, Sₗ is the whole area of the sector l.

3. A method according to claim 2 characterised that the value of parameter Eₐ is calculated from the following mathematical formula
$${E}_{a} = {\int }_{ω} {L}_{d} \cdot cos θ \cdot ⅆ ω$$
or alternatively from the another mathematical formula
$${E}_{a} = b \cdot \frac{{\int }_{{S}_{e}} {E}_{da} \cdot ⅆ {S}_{e}}{{S}_{e}}$$
wherein L_{d} is the luminance of the road observed by the driver and caused by the tested headlamps, ω is a solid angle with its top in the driver's eye where the illuminating surface of the road exists or a part of this angle in which there is the greatest luminance of the road responsible for the sight adaptation level of the human eye, b is a constant number which reflects the proportion between the illumination on the surface of the road and the illumination on the surface of the eye, θ is an angle between the line perpendicular to the surface of the driver's eye and the incident light beam, E_{da} is the illumination on the surface of the road which causes the luminance responsible for the sight adaptation level of the driver's eyes, Sₑ is the area of a plane which is perpendicular to the direction of the driver's sight line and through which the light beams reflected from the road surface incident to the eyes and, dSₑ is a differential of the area Sₑ.

4. A method according to claim 3 characterised that all the values of illumination and luminance used for the calculations are replaced by proportional non-linear functions.

5. A method according to claim 4 characterised that one of the non-linear functions is the logarithmic function.

6. A method according to claim 5 characterised that all the above mathematical calculations are made by means of computerised numerical methods.
